(19) United States
(12) Patent Application Publication
(10) Pub. No.: US 2017/0055158 A1
(43) Pub. Date: Feb. 23, 2017

(54) BASE STATION APPARATUS AND COMMUNICATION METHOD

(71) Applicant: FUJITSU LIMITED, Kawasaki-shi (JP)

(72) Inventor: DAISUKE OGAWA, Yokosuka (JP)

(73) Assignee: FUJITSU LIMITED, Kawasaki-shi (JP)

(21) Appl. No.: 15/346,815

(22) Filed: Nov. 9, 2016

Related U.S. Application Data
(63) Continuation of application No. PCT/JP2014/063749, filed on May 23, 2014.

(51) Int. Cl. H04W 16/10; H04W 28/06

(52) U.S. Cl. CPC H04W 16/10; H04W 28/06; H04W 88/02

(57) ABSTRACT

A base station apparatus includes a memory; and a processor coupled to the memory. The processor is configured to determine whether a communicating terminal under a first cell is present, the processor changing a frame configuration of uplink and downlink to a frame configuration suppressing interference with a second cell neighboring the first cell when the communicating terminal is absent.

### CROSS REFERENCE TO RELATED APPLICATIONS

This application is a continuation application of International Application PCT/JP2014/063749, filed on May 23, 2014, and designating the U.S., the entire contents of which are incorporated herein by reference.

### FIELD

The embodiments discussed herein relate to a base station apparatus and a communication method.

### BACKGROUND

Time Division Duplex (TDD) is a communication method and includes switching communications of uplink (UL: transmission from a terminal to a base station) and downlink (DL: transmission from a base station and a terminal) between a base station and a terminal on the basis of time slots.

FIG. 15 is a chart of a UL/DL configuration in a communication mode of LTE. For example, in a communication mode of Long Term Evolution (LTE) prescribed by 3GPP, arrangement of UL subframes for the UL and DL subframes for the DL is defined for each subframe (1 msec). In the example depicted in FIG. 15, a UL-subframe/DL-subframe configuration (hereinafter referred to as a UL/DL configuration) is defined in seven patterns each having 10 subframes (subframe numbers 0 to 9).

In FIG. 15, “D” denotes a DL subframe, “U” denotes a UL subframe, and “S” denotes a special sub-frame. The special sub-frame “S” is disposed between a DL subframe and a UL subframe (in the case of DL→UL) and is a subframe having DL and UL disposed in a mixed manner in one subframe.

FIG. 16 is a diagram for explaining interference by a CRS from a neighboring cell at the time of communication of a terminal. When multiple neighboring cells are present, the same UL/DL configuration is generally used between the neighboring cells in a TDD system. As depicted in FIG. 16, when two neighboring cells are present, these two cells (a cell #A and a cell #B) are temporally synchronized and use the same UL/DL configuration (pattern 2).

For example, both the cell #A and the cell #B use a DL subframe as the subframe at time t0 and use subframes of “S, U, D, D” in series at times t1 to t4. In this way, the same UL/DL configuration is used between neighboring cells.

The use of the same UL/DL configuration between neighboring cells will be described. It is assumed that a terminal (UE) #1 communicating with the cell #A and a UE #2 communicating with the cell #B are present in an area X and that the UE #1 and the UE #2 are located at places close to each other. It is also assumed that the UE #1 receives a signal in the UL/DL configuration (pattern 2) from the cell #A and that the UE #2 transmits a signal in the UL/DL configuration (pattern 0) to the cell B.

In this case, since the UE #1 and the UE #2 are located at places close to each other, the UE #1 receives a transmission signal of the UE #2 (D at time t3). From the viewpoint of the UE #1, the transmission signal of the UE #2 causes interference. To avoid such interference, a system using a communication method of TDD uses the same UL/DL configuration between neighboring cells as depicted in FIG. 16.

In the communication mode of LTE, a cell-specific reference signal (CRS) is multiplexed and transmitted in a DL subframe. A UE performs a power measurement and a channel estimation based on this CRS.

Returning to FIG. 16, it is assumed that a certain UE is communicating with the cell A. It is also assumed that the cell #B has no communicating user (UE). The two cells (the cell #A and the cell #B) both use the same UL/DL configuration (pattern 2).

With regard to the “D” DL subframe at time t3, contents of OFDM signals transmitted from respective base stations are extracted and depicted on the upper side (with horizontal and vertical axes indicating time and frequency, respectively). Each box (frame) in FIG. 16 is a resource element (RE), and various signals may be transferred through respective REs. For example, control channel data and individual channel data may be transferred through respective REs, and the cell #A and the cell #B multiplex and transmit a CRS (CRS-A) and a CRS (CRS-B), respectively, with arbitrary REs.

Because of the absence of a communicating user, the cell #B does not transmit the control channel data or the individual channel data and transmits only the CRS-B. However, this CRS-B acts as an interference signal for data corresponding to the RE having the CRS-B multiplexed therewith on the UE on the area X communicating with the cell #A in the DL subframe at time t3. This causes a problem of degradation of wireless performance (such as decreased transmission rate and decreased channel estimation accuracy) of the UE communicating with the other cell (cell #A).

To solve the interference problem as depicted in FIG. 16, a conceivable technique is to stop the CRS transmission of DL subframes (see, e.g., Japanese Laid-Open Patent Publication No. 2012-249118). By stopping the CRS transmission in the cell #B, the interference is no longer applied to a transmission signal from the cell A.

### SUMMARY

According to an aspect of an embodiment, a base station apparatus includes a memory; and a processor coupled to the memory. The processor is configured to determine whether a communicating terminal under a first cell is present, the processor changing a frame configuration of uplink and downlink to a frame configuration suppressing interference with a second cell neighboring the first cell when the communicating terminal is absent.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams of a communication system including a base station apparatus according to a first embodiment;

FIG. 2 is a block diagram of an internal configuration example of the base station apparatus according to the first embodiment;

FIG. 3 is a flowchart of an example of a process of UL/DL configuration change executed by the base station apparatus according to the first embodiment;

FIG. 4 is a flowchart of an example of a process after changing a UL/DL configuration executed by the base station apparatus according to the first embodiment;

FIG. 5 is a diagram for explaining UL/DL configuration control according to a second embodiment;

FIG. 6 is a diagram of an internal configuration example of base station apparatuses of the communication system according to the second embodiment;

FIG. 7 is a flowchart of an example of a process of UL/DL configuration change executed by one of neighboring base station apparatuses according to the second embodiment;

FIG. 8 is a flowchart of an example of a process of UL/DL configuration change executed by one of the neighboring base station apparatuses according to the second embodiment;

FIG. 9 is a flowchart of an example of a process after changing a UL/DL configuration executed by one of the neighboring base station apparatuses according to the second embodiment;

FIG. 10 is a sequence diagram of procedures related to a UL/DL configuration change in the communication system according to a third embodiment;

FIG. 11 is a chart of changes in the numbers of DL/UL subframes at the time of change in a DL/UL configuration according to a fourth embodiment;

FIG. 12 is a flowchart of an example of a process of UL/DL configuration change executed by the base station apparatus according to the fourth embodiment;

FIG. 13 is a flowchart of details of a process of determining the UL/DL configuration based on a data traffic amount according to the fourth embodiment;

FIG. 14 is a flowchart of another example of a process of UL/DL configuration change executed by the base station apparatus according to the fourth embodiment;

FIG. 15 is a chart of a UL/DL configuration in a communication mode of LTE; and

FIG. 16 is a diagram for explaining interference by a CRS from a neighboring cell at the time of communication of a terminal.

### DESCRIPTION OF THE INVENTION

Embodiments of the disclosed technique will be described in detail with reference to the accompanying drawings.

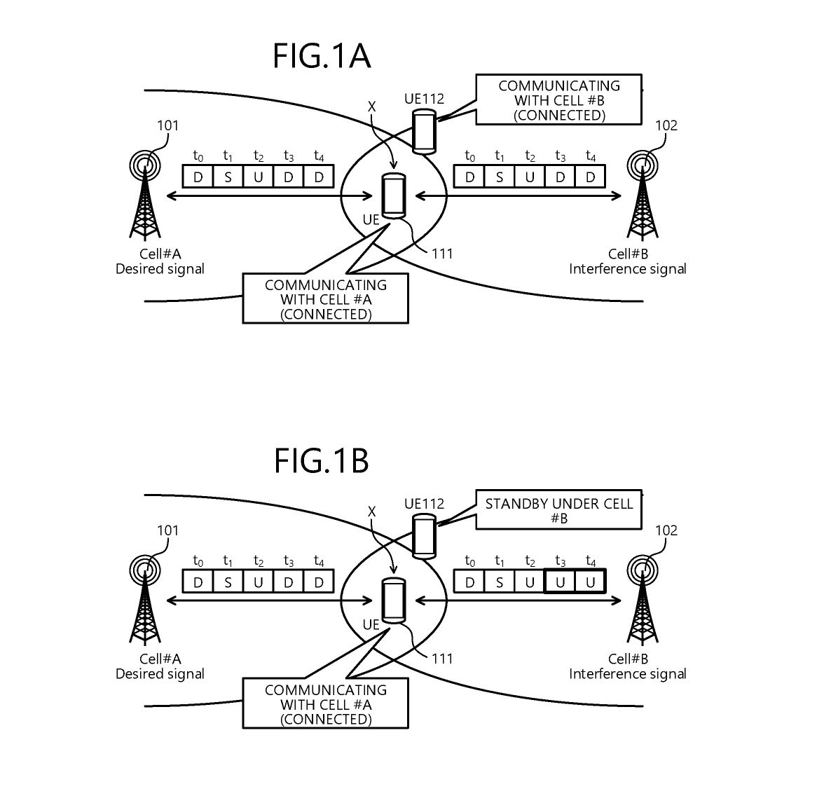

FIGS. 1A and 1B are diagrams of a communication system including a base station apparatus according to a first embodiment. As depicted in FIG. 1A, it is assumed that a base station apparatus (a base station, an enB) 101 and a base station 102 are arranged neighboring each other. A terminal (UE) 111 is located in an area X in which a cell (a cell #A, a second cell) of the base station 101 and a cell (a cell #B, a first cell) of the base station 102 overlap with each other, and the terminal (UE) 111 can communicate with the base station 101 of the cell #A and the base station 102 of the cell B. The terminal (UE) 111 is in communication connection with the base station 101 (cell #A), and another terminal (UE) 112 is in communication connection with the base station 102 (cell #B) under the cell B. Description will hereinafter be made of an example of application when the base stations 101, 102 and the terminals 111, 112 perform communication in a communication mode of LTE.

As depicted in FIG. 1B, it is assumed that a user (the UE 112) connected to the one cell #B is no longer present (the UE 112 is changed to a standby state under the cell #B). In this case, the base station 102 of the cell #B changes a UL/DL configuration (pattern) used in uplink (UL) and downlink (DL) communications with the UE 111. In this case, the base station 102 uses the UL/DL configuration suppressing the transmission of DL subframes “D” having multiplexed CRSs acting as an interference source for the terminal 111 located in the (area X) overlapping with the other cell A.

As depicted in FIG. 1A, the base station 101 of the cell #A and the base station 102 of the cell #B are assumed to have originally utilized the UL/DL configuration in a pattern 2 “DSUDD.” Subsequently, when determining that the user (the UE 112) connected to the cell #B is no longer present, the base station 102 changes the UL/DL configuration from the pattern 2 “DSUDD” to a pattern 0 “DSUUU” as depicted in FIG. 1B.

Since the user (the terminal 112) connected to the cell #B is not present, the base station 102 changes two subframes “DD” at times t3, t4 to “UU” in the pattern 0. However, since the user (the UE 112) using the subframes “UU” for UL transmission is not present, the subframes “UU” are substantially in a non-signal state. Therefore, the subframe “UU” of the cell #B does not interfere with the UE 111 located in the cell #A (the area X).

In this case, if all the terminals (UEs) under the cell #B go standby, the subframes “DD” at times t3, t4 are changed to “UU” in the pattern 0. Although the UE 112 is only one terminal under the cell #B in the example depicted in FIG. 1 for convenience, multiple terminals (UEs) are present in an actual system.

Since the DL subframes are changed to the UL subframes, no influence is exerted on the synchronization process of the UE 112 in the standby state (not in communication with the cell #B) located under the cell B. The UE 112 in the standby state under the cell #B executes the synchronization process by using the CRS included in the DL subframe “D” at the start (time t0) common to the patterns (see FIG. 15). As described above, the CSR is multiplexed and included in the DL subframe “D” and is not included in the UL subframe “U.”

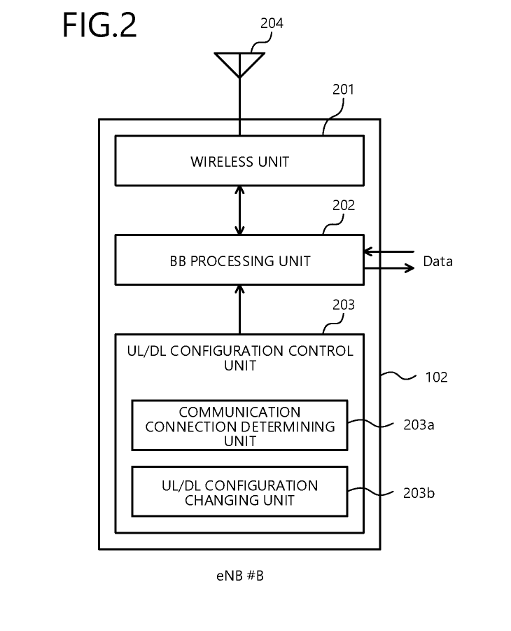

FIG. 2 is a block diagram of an internal configuration example of the base station apparatus according to the first embodiment. Although the same configuration is applicable to both the base stations 101, 102, an example of applying to the base station 102 of the cell #B depicted in FIG. 1 is depicted. The base station (eNB) 102 includes a wireless unit 201, a baseband (BB) processing unit 202, a UL/DL configuration control unit 203, and an antenna 204.

The wireless unit 201 is mainly made up of an analog circuit. The BB processing unit 202 and the UL/DL configuration control unit 203 each include a digital circuit, a DSP, a CPU, memories, etc. The CPU of the BB processing unit 202 executes a program stored in the memory (ROM) to execute a BB process by using the memory (RAM) as a work area. The CPU of the UL/DL configuration control unit 203 executes a program stored in the memory (ROM) to execute a process related to configuration control by using the memory (RAM) as a work area.

The BB processing unit 202 receives data (Data) through a network from an upper network and generates a BB signal. The BB signal is given to the wireless unit 201, and a wireless signal up-converted to a wireless frequency band is transmitted through the antenna 204. A wireless signal received by the antenna 204 is down-converted by the wireless unit 201 and subjected to a baseband process by the BB processing unit 202 before being output as data (Data) through the network to the upper network.

The UL/DL configuration control unit 203 provides control of a UL/DL configuration in a TDD system in the baseband process executed by the BB processing unit 202. The UL/DL configuration control unit 203 includes a communication connection determining unit 203a and a UL/DL configuration changing unit 203b.

The communication connection determining unit 203a determines whether a connected user (the UE 112) communicating under the cell #B is present. The UL/DL configuration changing unit 203b provides control of changing the UL/DL configuration (pattern) during a period without communication connection with the user (the UE 112) under the cell B. In this case, the UL/DL configuration is changed to a pattern that reduces interference with the neighboring cell (the cell #A). More specifically, the UL/DL configuration is changed to a pattern that reduces interference with the UE 111 located in the area X and in communication with the cell A.

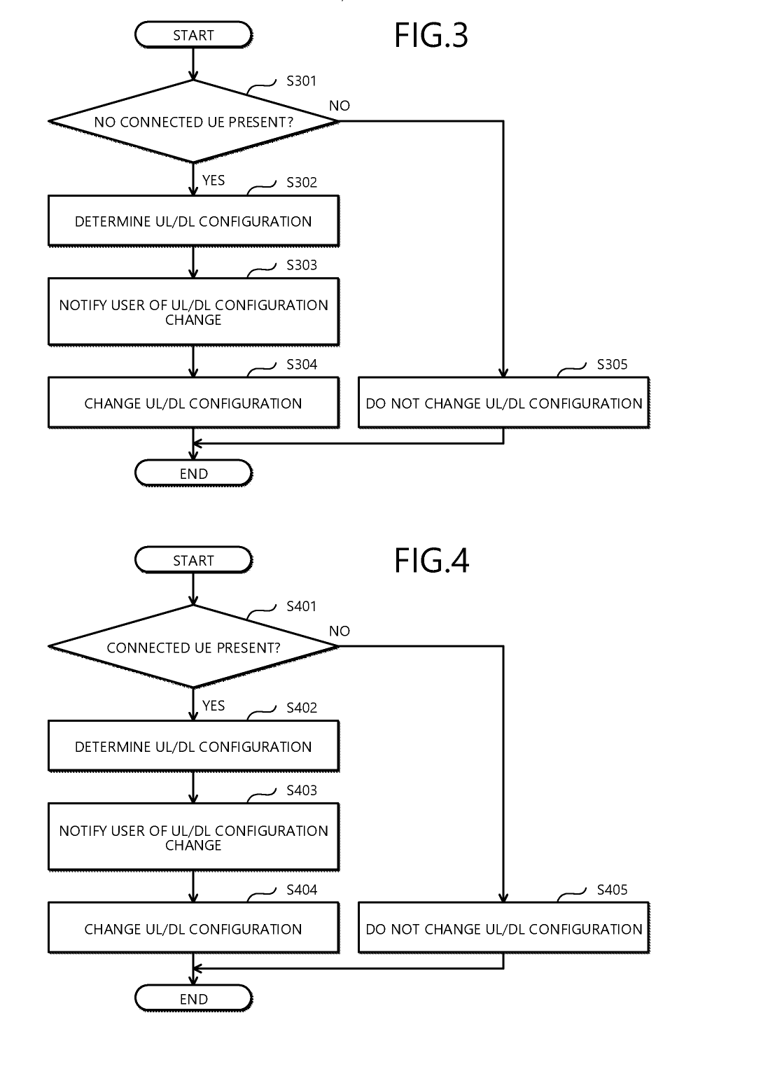

FIG. 3 is a flowchart of an example of a process of UL/DL configuration change executed by the base station apparatus according to the first embodiment. The UL/DL configuration changing control provided by the UL/DL configuration control unit 203 will be described.

In the initial state, as depicted in FIG. 1A, the same UL/DL configuration (e.g., the pattern 2 “DSUDD”) is used between the neighboring cells #A, B.

The UL/DL configuration control unit 203 determines whether no connected (CONNECTED) user (the UE 112) communicating under the cell #B is present (step S301).

If no connected user (the UE 112) is present (including when the UE 112 in the standby state is present) (step S301: YES), the UL/DL configuration control unit 203 determines a different UL/DL configuration (pattern) for changing the current UL/DL configuration (pattern) (step S302). In this case, the UL/DL configuration control unit 203 determines a UL/DL configuration (pattern) that reduces interference with the neighboring cell (cell #A).

The UL/DL configuration after the change is determined to be a pattern capable of reducing as far as possible interference with the neighboring cell due to CRSs multiplexed in the “D” DL subframes. Therefore, the UL/DL configuration control unit 203 selects a UL/DL configuration (pattern) having an increased number of the “U” UL subframes (a reduced number of the “D” DL subframes) (reducing the number of the DL subframes having multiplexed CRSs). For example, the UL/DL configuration control unit 203 determines to change the UL/DL configuration (pattern 2) to the UL/DL configuration (pattern 0).

As depicted in FIG. 15, the patterns 0 to 6 of the UL/DL configuration differ in the number of the DL subframes acting as a source of interference. The ascending order of the number of the DL subframes “D” is the pattern 0 (with two Ds), the pattern 6 (with three Ds), the pattern 1 (with four Ds), the patterns 2 and 3 (with six Ds), the pattern 4 (with seven Ds), and the pattern 5 (with eight Ds). The UL/DL configuration control unit 203 may preferentially select (determine) the UL/DL configuration of the pattern with a reduced number of the DL subframes “D” (pattern with an increased number of the UL subframes), for example.

As a result, the user (the UE 111) located in the area X and communicating with the cell #A has a fewer number of the DL subframes having multiplexed CRSs and transmitted from the cell B. Therefore, a signal-to-interference ratio (SIR) may be improved in communication using subframes corresponding to the DL subframes having multiplexed CRSs, and degradation of wireless performance (such as transmission rate and channel estimation accuracy) may be suppressed so as to maintain high-speed communication.

The UL/DL configuration control unit 203 notifies (the user (the UE 112) in the standby state under) the cell #B of the UL/DL configuration change (step S303).

The user (the UE 112) in the standby (idle) state under the cell #B is maintaining the synchronization by using CRSs multiplexed in DL subframes. Since a sudden change in the UL/DL configuration (elimination of DL subframes “D”) of the user (the UE 112) causes a degradation of synchronization performance, the user (the UE 112) is preliminarily notified of the change in the UL/DL configuration at step S303. This notification is made by using a paging message, for example. The preliminary notification of the change in the UL/DL configuration enables the user (the UE 112) to perform the control of executing the synchronization process by using the CRS included in the DL subframe “D” included at least at the head and common to the patterns.

After completion of the notification of the change in UL/DL configuration at step S303, the UL/DL configuration control unit 203 changes the UL/DL configuration of the cell #B (step S304). For example, as depicted in FIG. 1B, the cell #B changes the UL/DL configuration to the pattern 0 “DSUUU,” for example.

In the communication mode of LTE, the notification of the information of the UL/DL configuration is made as system information (System Information Block Type 1) of radio resource control (RRC: radio resource control procedure). Therefore, the base station 102 sends out to the cell #B (notifies the UE 112 of) System Information Block Type 1 including the UL/DL configuration having the contents rewritten to the changed contents and terminates the process (returns to step S301 and waits).

If a connected user (the UE 112) is present at step S301 (step S301: NO), the UL/DL configuration control unit 203 does not change the UL/DL configuration (step S305) and terminates the process. In this case, the UL/DL configuration is maintained as the pattern 2.

FIG. 4 is a flowchart of an example of a process after changing a UL/DL configuration executed by the base station apparatus according to the first embodiment. The control after the UL/DL configuration change in FIG. 3 will be described.

It is assumed that in the initial state, the UL/DL configuration of the cell #B has been changed to, for example, the pattern 0 “DSUUU” because of the execution of the process of FIG. 3 described above (see FIG. 1).

The UL/DL configuration control unit 203 determines whether a connected (CONNECTED) user (the UE 112) communicating under the cell #B is present (step S401). By starting step S401, for example, if the UE 112 is called by data input from the upper network to the base station 102, it is determined that a connected (CONNECTED) user (the UE 112) is present when the UE 112 activates a browser, etc. to request data transmission through the UL, for example.

If a connected user (the UE 112) is present (step S401: YES), the UL/DL configuration control unit 203 determines a different UL/DL configuration (pattern) for changing the current UL/DL configuration (step S402). For example, the UL/DL configuration is changed to the originally-used UL/DL configuration (returned to the pattern 2 “DSUDD”).

The UL/DL configuration control unit 203 notifies the user (UE 112) in the standby state under the cell #B of the UL/DL configuration change (returning to the pattern 2 “DSUSS”) (step S403). The UL/DL configuration control unit 203 notifies the user (UE 112) in the standby (idle) state under the cell #B of the change in the UL/DL configuration by using a paging message as described above.

After completion of the notification of the change in the UL/DL configuration at step S403, the UL/DL configuration control unit 203 changes the UL/DL configuration of the cell #B (step S404). The UL/DL configuration control unit 203 then terminates the process in FIG. 4 (returns to step S301 of FIG. 3).

If no connected user (the UE 112) is present at step S401 (step S401: NO), the UL/DL configuration control unit 203 does not change the UL/DL configuration (step S405) and terminates the process (returns to step S401). In this case, the UL/DL configuration is maintained as the pattern 0.

The above process enables a reduction in the interference while maintaining compatibility with the communication mode of LTE. During a period without a communicated user (UE) communicating with the cell of the base station, the base station changes the UL/DL configuration to temporarily change the DL subframes having multiplexed CRSs to the UL subframes. This reduces the number of the DL subframes having multiplexed CRSs. As a result, interference due to CRSs may be reduced for the user (terminal) communicating with a neighboring cell in an overlapping area between the cell of the base station and the neighboring cell, and the degradation of wireless performance at the terminal may be suppressed.

Even during this period of the changed UL/DL configuration, the terminal (on standby) not communicating under the cell may execute the synchronization process based on the CRS multiplexed in a portion of the DL subframes so that the deterioration in the synchronization performance may be prevented.

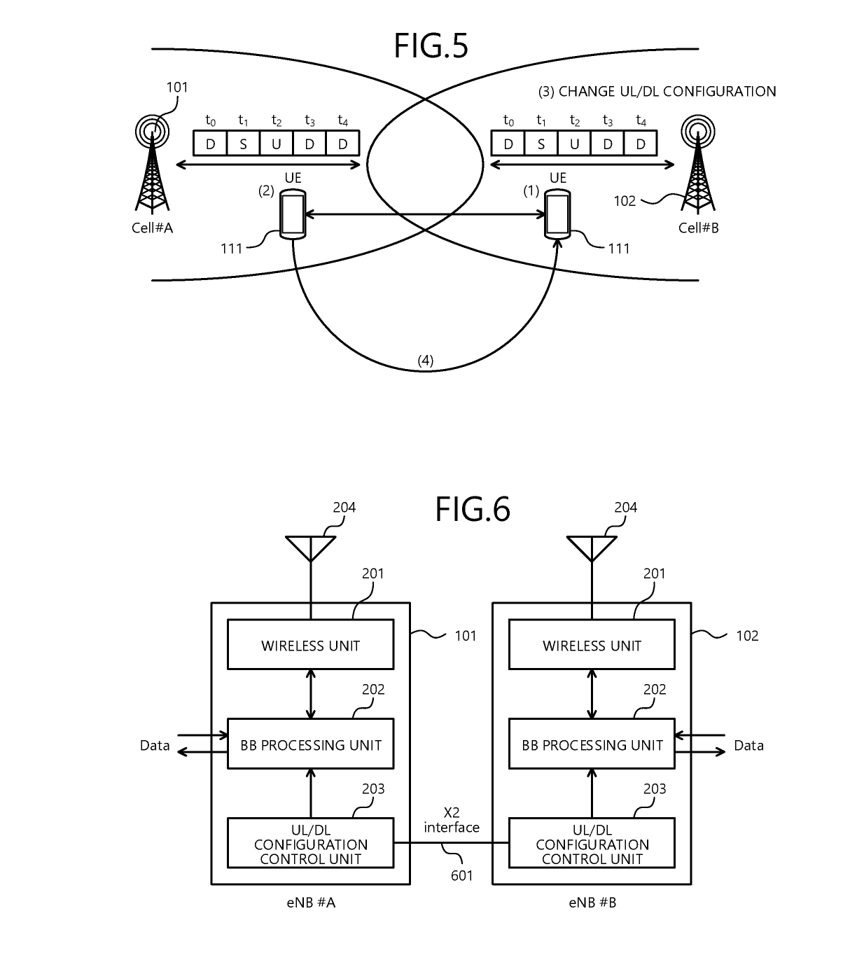

FIG. 5 is a diagram for explaining UL/DL configuration control according to a second embodiment. In the second embodiment, the neighboring cells #A and #B cooperate with each other to exchange, and notify the UE 111 of, information on change in the UL/DL configuration. After a user (the UE 111) moves to another cell, the base station 102 of the cell #B provides control of matching the UL/DL configuration when the user returns to the original cell again.

For example, it is assumed that: (1) a certain user (the UE 111) communicated with the cell #B; (2) a handover (HO) is executed from the cell #B to the cell #A; (3) the UL/DL configuration of the cell #B (the base station 102) is changed (the UL/DL configuration is changed because the communicating user is no longer present in the cell #B on the basis of (2)); and (4) the user returns from the cell #A to the cell #B and an HO is executed.

This user (the UE 111) retains the UL/DL configuration when the user was initially located in the cell #B and may execute Measurement (quality measurement) by using the UL/DL configuration before the change at (3) when the HO is executed again to the cell #B at (4).

The user (the UE 111) uses a CRS in the Measurement process. Therefore, when the HO is executed at (4), the user may execute the Measurement process by using, as a DL subframe, a subframe changed to UL since the previous UL/DL configuration is different from (mismatched with) the UL/DL configuration at the time of the HO. In this case, the Measurement performance degrades, causing a problem of an inability to execute HO to the optimum cell.

In the second embodiment, the base station 102 of the cell #B notifies the base station 101 in the neighboring cell (the cell #A) of the changed UL/DL configuration. The user (the UE 111) under the cell #A is notified of the change in the UL/DL configuration.

FIG. 6 is a diagram of an internal configuration example of base station apparatuses of a communication system according to the second embodiment. In FIG. 6, the same constituent elements as the first embodiment (FIG. 2) are denoted by the same reference numerals used in the first embodiment. In the second embodiment, the base stations 101, 102 of the neighboring cells (the cells #A and #B) establish communication connections between the respective UL/DL configuration control units 203. For example, a transmission path (e.g., X2 interface) 601 between the base station 101 of the cell #A and the base station 102 of the cell #B may be used. The transmission path 601 may be another wired interface or a wireless transmission path.

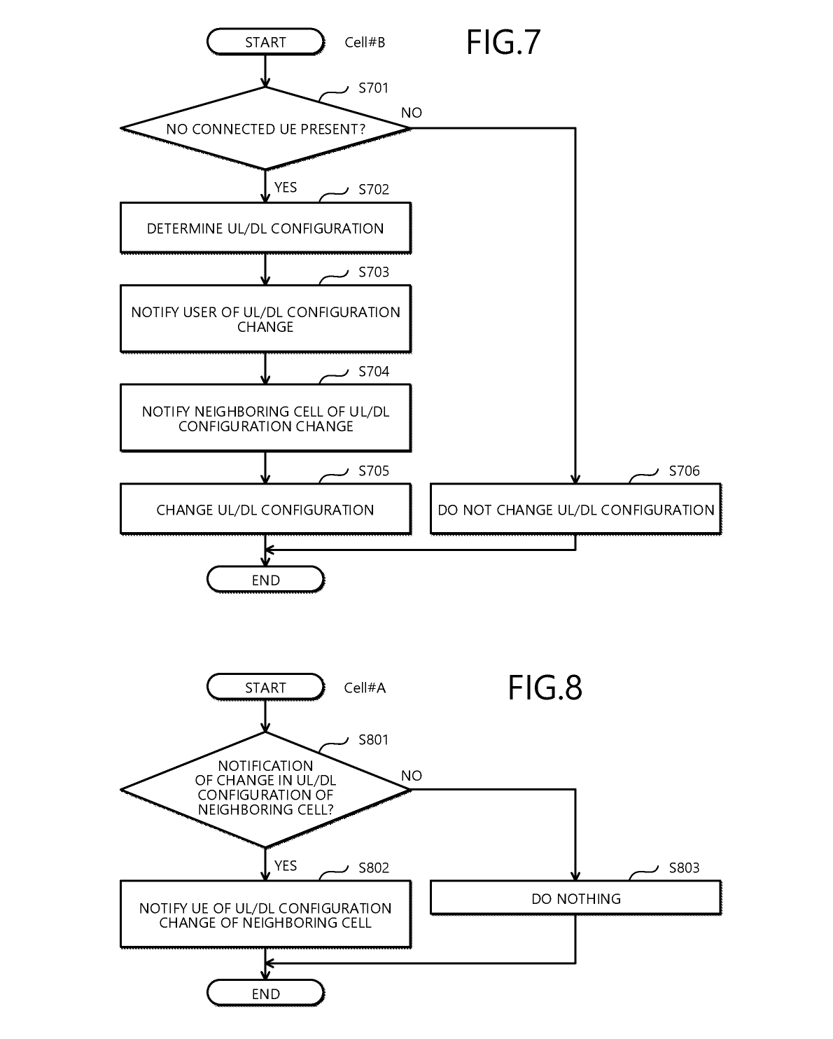

FIG. 7 is a flowchart of an example of a process of UL/DL configuration change executed by one of the neighboring base station apparatuses according to the second embodiment. FIG. 7 depicts the process of the cell #B (the base station 102) before (2) the HO of the user (the UE 111) depicted in FIG. 5.

The UL/DL configuration control unit 203 of the cell #B (the base station 102) determines whether no connected (CONNECTED) user (the UE 112) communicating under the cell #B is present (step S701).

If no connected user (the UE 112) is present (including when the UE 112 in the standby state is present) (step S701: YES), the UL/DL configuration control unit 203 determines a different UL/DL configuration (pattern) for changing the current UL/DL configuration (pattern) (step S702). In this case, the UL/DL configuration control unit 203 determines a UL/DL configuration (pattern) that reduces interference with the neighboring cell (cell #A). For example, the UL/DL configuration control unit 203 determines to change the UL/DL configuration (pattern 2) to the UL/DL configuration (pattern 0).

The UL/DL configuration control unit 203 notifies (the user (the UE 112) in the standby state under) the cell #B of the UL/DL configuration change (step S703).

The UL/DL configuration control unit 203 notifies through the transmission path 601 the neighboring cell (the base station 101 of the cell #A) of the UL/DL configuration change (step S704). Steps S703 and S704 may be executed in reverse order or at the same time.

Subsequently, the UL/DL configuration control unit 203 changes the UL/DL configuration of the cell #B (step S705). For example, as depicted in FIG. 1, the cell #B is changed in the UL/DL configuration to the pattern 0 “DSUUU,” for example. The base station 102 sends out to the cell #B (notifies the UE 112 of) System Information Block Type 1 including the UL/DL configuration having the contents rewritten to the changed contents and terminates the process (returns to step S701 and waits).

If a connected user (the UE 112) is present at step S701 (step S701: NO), the UL/DL configuration control unit 203 does not change the UL/DL configuration (step S706) and terminates the process. In this case, the UL/DL configuration is maintained as the pattern 2.

FIG. 8 is a flowchart of an example of a process of UL/DL configuration change executed by one of the neighboring base station apparatuses according to the second embodiment. FIG. 8 depicts the process of the cell #A (the base station 101) that is the destination of (2) the HO of the user (the UE 111) depicted in FIG. 5. It is noted only the process details related to the notification of change in the UL/DL configuration are extracted from the cell #B and described.

First, the UL/DL configuration control unit 203 of the cell #A (the base station 101) determines whether notification of a change in the UL/DL configuration is given by the base station 102 of the neighboring cell (the cell #B) (step S801).

If notification of a change in the UL/DL configuration is given (step S801: YES), the UL/DL configuration control unit 203 notifies the user (UE 111) under the cell #A of the changing of the UL/DL configuration of the neighboring cell (the cell #B) (step S802) and terminates the process. This notification is made by using a paging channel or a broadcast channel, for example.

The user (UE 111) retains the changed UL/DL configuration (e.g., the pattern 0 “DSUUU”) for the cell B. As a result, when returning to the cell #B again (at the time of HO), the user (the UE 111) may know the UL/DL configuration (e.g., the pattern 0 “DSUUU”) currently utilized in the cell B. Therefore, the user (the UE 111) may match the UL/DL configuration with that currently utilized in the cell #B (by the base station 102) so as to perform communication.

On the other hand, if no notification of a change in the UL/DL configuration is given (step S801: NO), the UL/DL configuration control unit 203 does nothing (step S803) and terminates the process.

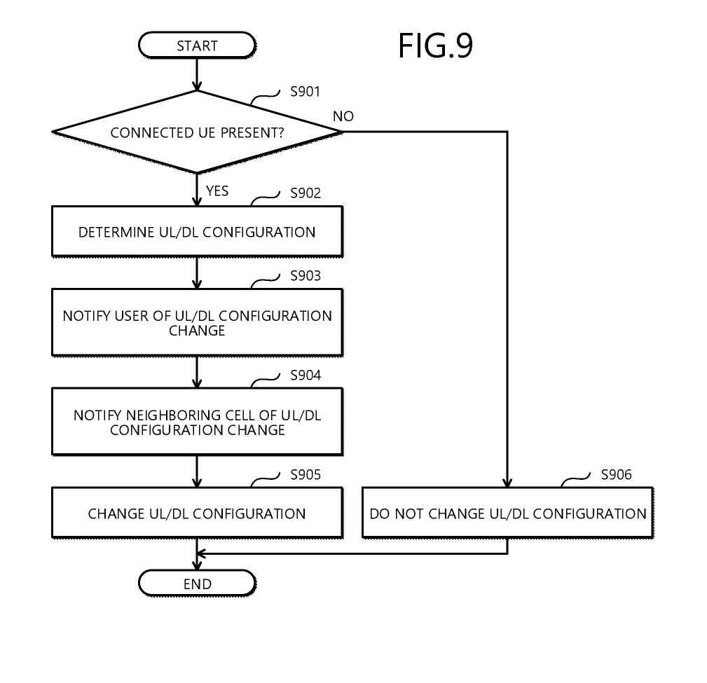

FIG. 9 is a flowchart of an example of a process after changing a UL/DL configuration executed by one of the neighboring base station apparatuses according to the second embodiment. The control after the change in the UL/DL configuration of FIG. 7 will be described.

It is assumed that in the initial state, the UL/DL configuration of the cell #B (the base station 102) has been changed to, for example, the pattern 0 “DSUUU” because of the execution of the process of FIG. 3 described above (see FIG. 1).

The UL/DL configuration control unit 203 of the cell #B (the base station 102) determines whether a connected (CONNECTED) user (the UE 112) communicating under the cell #B is present or absent (step S901).

If a connected user (the UE 112) is present (step S901: YES), the UL/DL configuration control unit 203 determines a different UL/DL configuration (pattern) for changing the current UL/DL configuration (step S902). For example, the UL/DL configuration is changed to the originally-used UL/DL configuration (returned to the pattern 2 “DSUDD”).

The UL/DL configuration control unit 203 notifies (the user (UE 112) in the standby state under) the cell #B of the UL/DL configuration change (returning to the pattern 2 “DSUDD”) (step S903).

The UL/DL configuration control unit 203 notifies through the transmission path 601 the neighboring cell (the base station 101 of the cell #A) of the UL/DL configuration change (returning to the pattern 2 “DSUDD”) (step S904). Steps S903 and S904 may be executed in reverse order or at the same time.

Subsequently, the UL/DL configuration control unit 203 changes the UL/DL configuration of the cell #B (step S905). The process of FIG. 9 is then terminated (returned to step S701 of FIG. 7).

If no connected user (the UE 112) is present at step S901 (step S901: NO), the UL/DL configuration control unit 203 does not change the UL/DL configuration (step S906) and terminates the process (returns to step S901). In this case, the UL/DL configuration is maintained as the pattern 0.

The second embodiment has the same effects as the first embodiment. Additionally, in the second embodiment, after moving to a neighboring cell, the user (UE 111) may be notified of a change in the UL/DL configuration in the previous cell. As a result, when returning to the previous cell again, the user (the UE 111) may perform communication using the UL/DL configuration being utilized.

This enables prevention of a mismatched state in which the previous UL/DL configuration is different from the UL/DL configuration at the time of HO, so as to properly perform the quality measurement and to properly execute the HO.

A third embodiment is a modification example of the second embodiment and is differs in the timing of notification of UL/DL configuration information of the handover-destination cell (the cell #B) to the UE 111. In the third embodiment, at the time of handover of the user (the terminal 111) returning to the original cell (the cell #B), the cell (the cell #A) adds the UL/DL configuration information of the handover-destination cell (the cell #B) to a wirelessly-transmitted message so as to make the notification.

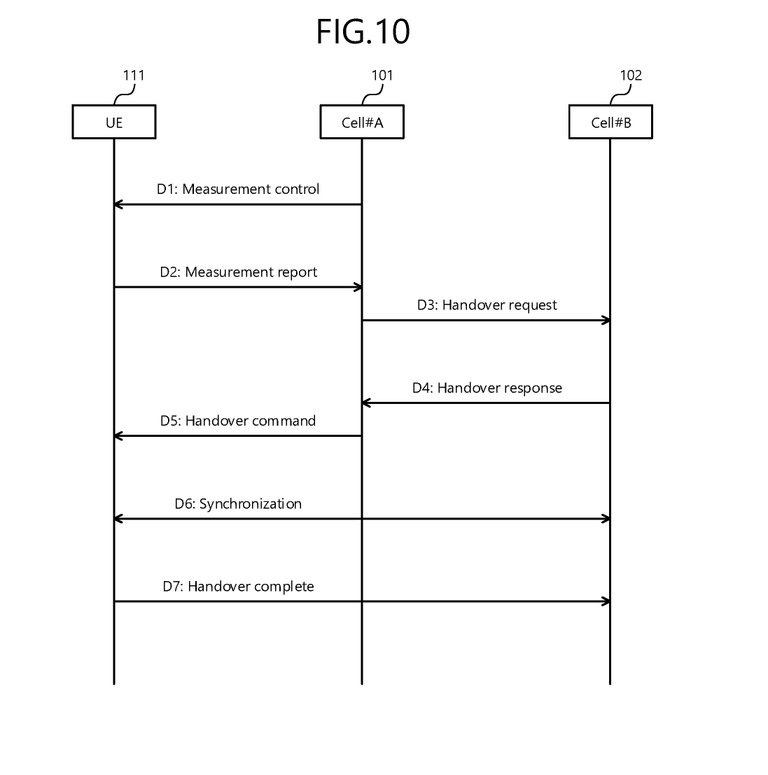

FIG. 10 is a sequence diagram of procedures related to a UL/DL configuration change in the communication system according to the third embodiment. FIG. 10 depicts the procedures executed when the user (the UE 111) moves (the handover is executed) from the cell #A (the base station 101) to the cell #B (the base station 102) as depicted in FIG. 5 (the state when the UE 111 returns to the cell #B in FIG. 5).

In this case, the cell #A (the base station 101) sends a Measurement request (control) to the user (the UE 111) (D1). The UE 111 executes the Measurement (quality measurement) and reports an execution result (Measurement report) to the cell #A (the base station 101) (D2).

If the cell #A determines that HO should be executed based on the Measurement report reported from the UE 111, the cell #A (the base station 101) sends an HO request (Handover request) to the neighboring cell #B (the base station 102) (D3). The cell #B (the base station 102) receiving the HO request executes a procedure in preparation for the HO of the object UE 111 and sends an HO response (Handover response) to the cell #A (the base station 101) (D4).

The cell #A (the base station 101) transmits a Handover command to the UE 111 to give an HO instruction from the UE 111 to the cell #B (the base station 102) (D5). The UE 111 ensures synchronization (Synchronization) with the cell #B (the base station 102) (D6) and then notifies the HO-destination cell #B (the base station 102) of completion of the HO (Handover complete) (D7).

In the communication mode of LTE, HO is executed according to the procedures D1 to D7 described above. Since the UL/DL configuration of TDD is not transmitted to the UE 111 in the procedure D1, the procedures cannot deal with the time of HO of the UE 111 (the situation of (1) to (4) of FIG. 5).

In the second embodiment described above, the cell #B (the base station 102) notifies through the transmission path (e.g., X2 interface) 601 the cell #A (the base station 101) of the change in the UL/DL configuration. The cell #A (the base station 101) notifies the UE 111 of the UL/DL configuration of the cell #B (the base station 102) by using a paging channel or a broadcast channel.

In contrast, in the third embodiment, the notification of the change in the UL/DL configuration is made without using a paging channel or a broadcast channel. In the third embodiment, at the time of the handover of the UE 111, when the cell #A (the base station 101) transmits the measurement control to the UE 111 (the procedure D1), the notification of the UL/DL configuration of the HO-destination cell #B (the base station 102) is also made. For example, the UL/DL configuration information of cells (e.g., bits corresponding to pattern numbers) may be set in the Measurement Object information used in communication standards of 3GPP for making the notification. It is noted that the cell #A preliminarily acquires the current UL/DL configuration of the cell #B at the time of execution of the procedure D1.

If no connected user (the UE 112) communicating under the cell #B (the base station 102) is present, a connected user (the UE 112) becomes present when the cell #B (the base station 102) receives the Handover complete from the UE 111 (the procedure D7), because HO is a state of being in communication. In this case, with the HO complete of the procedure 7 as a trigger, the cell #B (the base station 102) executes the process described in the second embodiment (FIG. 9) to change (restore) the UL/DL configuration.

The third embodiment described above has the same effects as the second embodiment in addition to the effects of the first embodiment. In the third embodiment, at the time of handover of the terminal, a notification of the UL/DL configuration of the handover destination may be made by using a message to the terminal. As a result, the terminal does not have to retain the information of the UL/DL configuration of the handover destination until the handover is actually executed. The terminal may be notified of the latest UL/DL configuration related to the handover-destination cell at the timing of actual movement so that the handover may properly be executed. The UE may be easily notified of a change in the UL/DL configuration by using the existing LTE procedures.

A fourth embodiment relates to a method of determining a UL/DL configuration described in the first embodiment. The base station 102 of the cell (the cell #B) determines the UL/DL configuration (the optimum pattern out of the patterns 0 to 6) corresponding to the data traffic amount in the cell (the cell #B) (a data traffic amount of the connected user (the UE 112) communicating under the cell).

For example, in the first embodiment described above, when the UE 112 under the cell #B (the base station 102) is no longer present, the UL/DL configuration is changed to an arbitrary pattern (see FIG. 1; e.g., changed from the pattern 2 to the pattern 0).

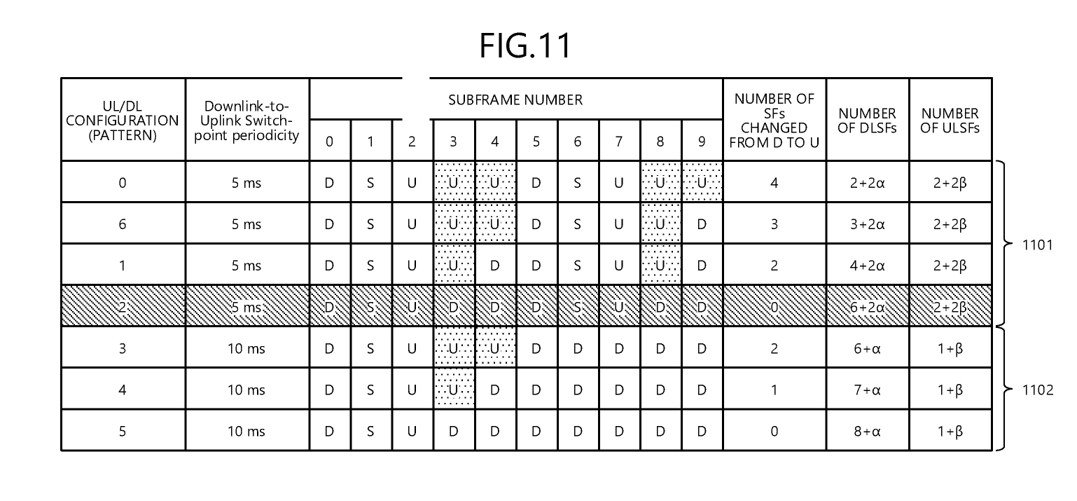

FIG. 11 is a chart of changes in the numbers of DL/UL subframes at the time of change in a DL/UL configuration according to the fourth embodiment. FIG. 11 depicts the arrangement of the DL/UL subframes of the respective patterns as in FIG. 15 as well as the number of subframes (SFs) changed from to “U,” the number of subframes usable as the “D” subframes (the number of DLSFs), and the number of subframes usable as the subframes (the number of ULSFs).

In FIG. 11, the pattern 2 at the center is defined as a reference pattern, and the number of SFs changed from D to U, the number of DLSFs, and the number of ULSFs are described for each pattern changed from the pattern 2. For example, in the pattern 0, the number of SFs changed from D to U due to the change from the pattern 2 is four. In the pattern 5, the number of SFs changed from D to U due to the change from the pattern 2 is zero.

Additionally, α indicates an amount of data communicable as DL in the “S” subframe in which DL and UL are mixed, and β indicates an amount of data communicable as UL in the “S” subframe. For example, when an amount of data communicable in one DL subframe is one, a may be a positive value less than one, and when an amount of data communicable in one UL subframe is one, β may be a positive value less than one. The numbers described as the numbers of ULSFs do not include the number of ULSFs changed from DL to UL.

In FIG. 11, when the pattern 2 at the center is used as a reference, the patterns 0, 6, and 1 (a pattern group 1101 including the pattern 2) depicted on the upper side of FIG. 11 have the larger numbers of usable UL subframes as compared to the patterns 3, 4, and 5 (a pattern group 1102) depicted on the lower side of FIG. 11. Conversely, the patterns 3, 4, and 5 (the pattern group 1102) depicted on the lower side of FIG. 11 have the larger numbers of usable DL subframes as compared to the patterns 0, 6, and 1 (the pattern group 1101 including the pattern 2) depicted on the upper side of FIG. 11.

The base station 102 of the cell #B selects a suitable pattern from the pattern group 1101 when the data traffic amount of DL is large, and selects a suitable pattern from the pattern group 1102 when the data traffic amount of UL is large.

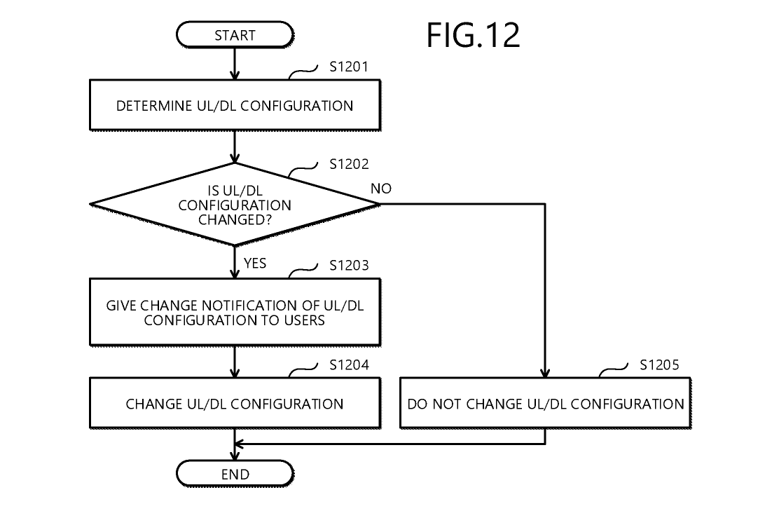

FIG. 12 is a flowchart of an example of a process of UL/DL configuration change executed by the base station apparatus according to the fourth embodiment. The UL/DL configuration changing control provided by the UL/DL configuration control unit 203 of the cell #B (the base station 102) will be described.

First, the UL/DL configuration control unit 203 determines a UL/DL configuration based on the data traffic amount of the cell #B (step S1201). The UL/DL configuration control unit 203 determines whether the determined UL/DL configuration is changed from the currently used UL/DL configuration (step S1202).

If it is determined at step S1202 that the UL/DL configuration is changed (step S1202: YES), the UL/DL configuration control unit 203 gives change notification of the UL/DL configuration to the users (the UE 112) (step S1203). The UL/DL configuration control unit 203 makes the change to the UL/DL configuration determined at step S1201 (step S1204). Unlike the first embodiment, the change notification at step S1203 is made to all the users (the UEs 112) communicating in the cell B.

If it is determined at step S1202 that the UL/DL configuration is not changed (step S1202: NO), the UL/DL configuration control unit 203 does not change the UL/DL configuration (step S1205) and terminates the process.

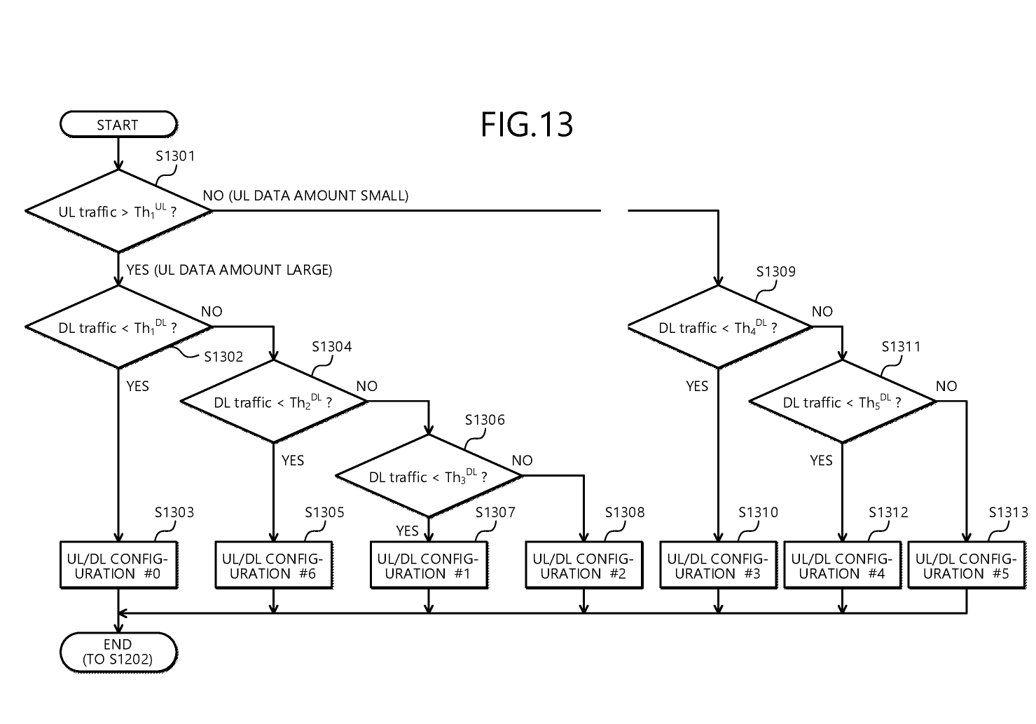

FIG. 13 is a flowchart of details of a process of determining the UL/DL configuration based on a data traffic amount according to the fourth embodiment. Details of the process of step S1201 of FIG. 12 executed by the UL/DL configuration control unit 203 will be described.

As depicted in FIG. 11, when the pattern 2 of the UL/DL configuration is used as the reference pattern for making a change, the number of ULSFs is either 2+2β or 1+β. Therefore, the UL/DL configuration control unit 203 determines whether the UL/DL configuration is selected from the patterns on the 2+2β side (the patterns 0, 6, 1, 2) or the patterns on the 1+β side (the patterns 3, 4, 5), corresponding to the UL data amount.

First, if the UL data amount exceeds a threshold value Th₁^{UL} (step S1301: YES), it is desirable for the UE 112 to use a large data amount for performing communications in this situation and therefore, the UL/DL configuration control unit 203 selects the 2+2β pattern group 1101 (the patterns 0, 6, 1, 2) to execute the processes of steps S1302 to S1308.

The UL/DL configuration control unit 203 determines the number of DLSFs (steps S1302 to S1308). When selecting the 2+2β pattern group 1101 (the patterns 0, 6, 1, 2) at step S1301, the UL/DL configuration control unit 203 selects one optimum pattern from four patterns of 2+2α, 3+2α, 4+2α, and 6+2α for the number of DLSFs.

Therefore, the UL/DL configuration control unit 203 compares the DL data amount with multiple predetermined thresholds (Th₁^{DL} to Th₃^{DL}, where Th₁^{DL}<Th₂^{DL}<Th₃^{DL}) to determine the UL/DL configuration.

When the DL data amount is less than the threshold value Th₁^{DL} (step S1302: YES), the UL/DL configuration control unit 203 determines the pattern 0 having the largest UL data amount (the smallest DL data amount) as the UL/DL configuration (step S1303) and goes to step S1202 (see FIG. 12).

When the DL data amount is equal to or greater than the threshold value Th₁^{DL} (step S1302: NO), the UL/DL configuration control unit 203 compares the DL data amount with the threshold value Th₂^{DL} (step S1304) and, when the DL data amount is less than the threshold value Th₂^{DL} (step S1304: YES), the UL/DL configuration control unit 203 determines the pattern 6 as the UL/DL configuration (step S1305).

When the DL data amount is equal to or greater than the threshold value Th₂^{DL} (step S1304: NO), the UL/DL configuration control unit 203 compares the DL data amount with the threshold value Th₃^{DL} (step S1306) and, when the DL data amount is less than the threshold value Th₃^{DL} (step S1306: YES), the UL/DL configuration control unit 203 determines the pattern 1 as the UL/DL configuration (step S1307). When the DL data amount is equal to or greater than the threshold value Th₃^{DL} (step S1306: NO), the UL/DL configuration control unit 203 determines the pattern 2 as the UL/DL configuration (step S1308).

On the other hand, when the UL data amount is equal to or less than a threshold value Th₁^{UL} (step S1301: NO), the UL data amount is smaller (the DL data amount is larger) in this situation. In this case, the UL/DL configuration control unit 203 selects the 1+β pattern group 1102 (the patterns 3, 4, 5) to execute the processes of steps S1309 to S1313.

Therefore, the UL/DL configuration control unit 203 compares the DL data amount with multiple predetermined thresholds (Th₄^{DL} and Th₅^{DL}, where Th₄^{DL}<Th₅^{DL}) to determine the UL/DL configuration.

When the DL data amount is less than the threshold value Th₄^{DL} (step S1309: YES), the UL/DL configuration control unit 203 determines the pattern 3 as the UL/DL configuration (step S1310) and goes to step S1202 (see FIG. 12).

When the DL data amount is equal to or greater than the threshold value Th₄^{DL} (step S1309: NO), the UL/DL configuration control unit 203 compares the DL data amount with the threshold value Th₅^{DL} (step S1311) and, when the DL data amount is less than the threshold value Th₅^{DL} (step S1311: YES), the UL/DL configuration control unit 203 determines the pattern 4 as the UL/DL configuration (step S1312). When the DL data amount is equal to or greater than the threshold value Th₅^{DL} (step S1311: NO), the UL/DL configuration control unit 203 determines the pattern 5 having the largest DL data amount (the smallest UL data amount) as the UL/DL configuration (step S1313)

The determination of the optimum UL/DL configuration described above has been described as a process executed solely by the UL/DL configuration control unit 203 of the cell #B (the base station 102) according to the first embodiment. This is not a limitation and the determination may be applied in the same way to the process of the neighboring cells #A and #B cooperating with each other to exchange information on a change in the UL/DL configuration as described in the second and third embodiments.

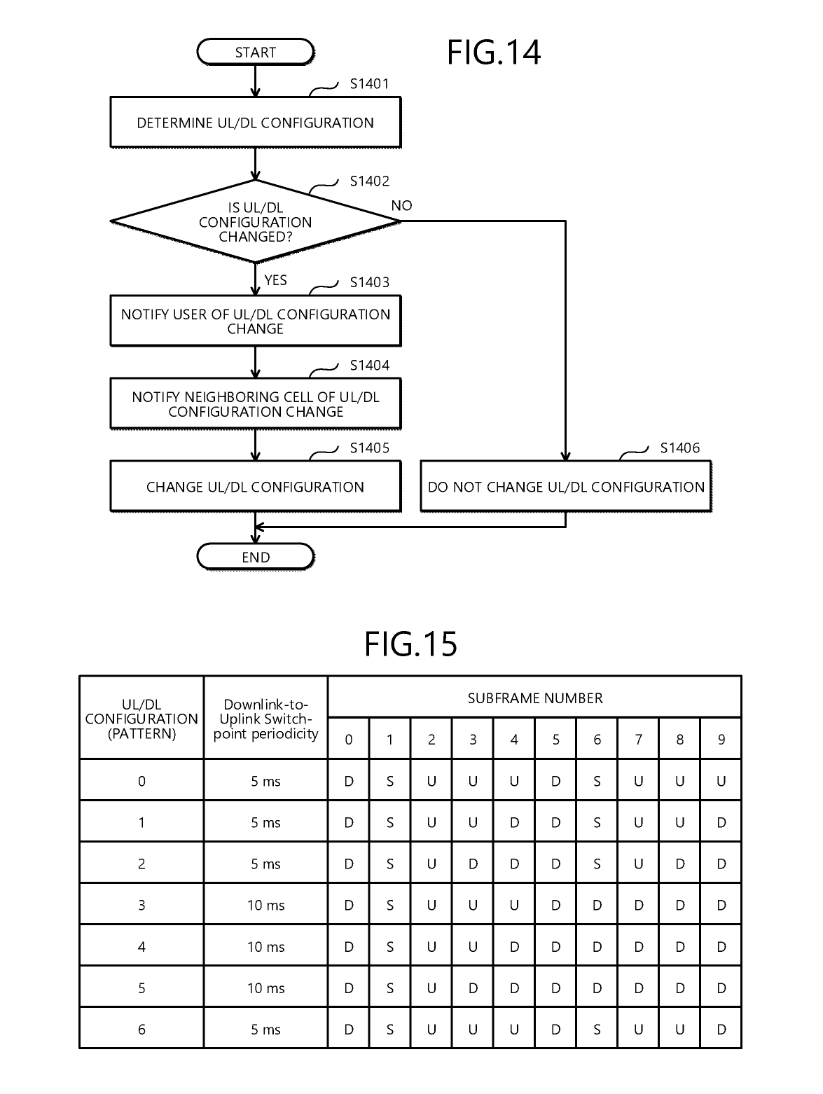

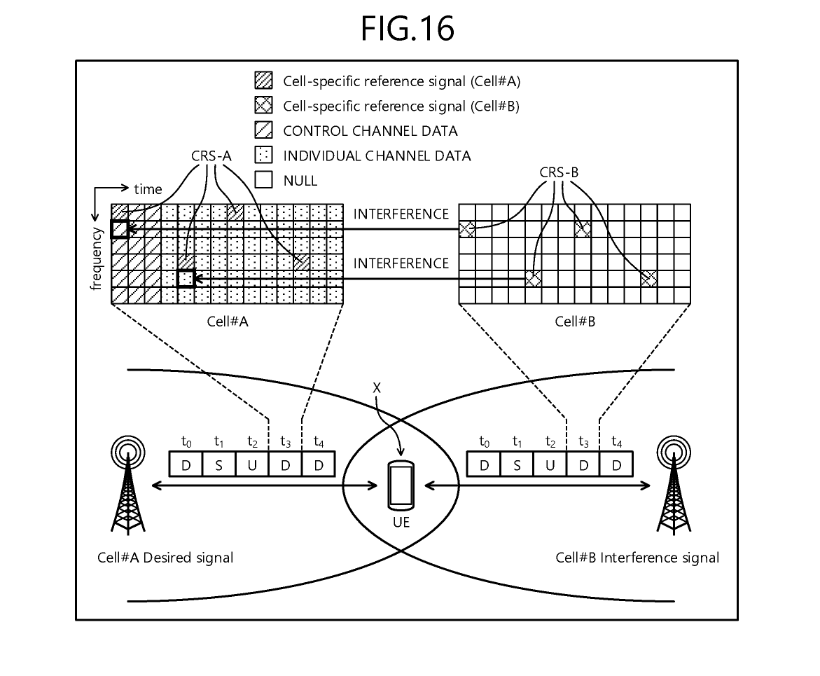

FIG. 14 is a flowchart of another example of a process of UL/DL configuration change executed by the base station apparatus according to the fourth embodiment. Description will be made of details of the process executed by the UL/DL configuration control unit 203 of the cell #B (the base station 102) when the determination of the optimum UL/DL configuration depicted in FIG. 13 is applied to the second embodiment (and the third embodiment).

First, the UL/DL configuration control unit 203 executes the process of determining the UL/DL configuration depicted in FIG. 13 based on the data traffic amount of the cell #B (step S1401). The UL/DL configuration control unit 203 then determines whether the determined UL/DL configuration is changed from the currently used UL/DL configuration (step S1402).

If it is determined at step S1402 that the UL/DL configuration is changed (step S1402: YES), the UL/DL configuration control unit 203 gives change notification of the UL/DL configuration to a standby user (the UE 112) (step S1403). The UL/DL configuration control unit 203 then notifies the neighboring cell (the base station 101 of the cell #A) of the changing of the UL/DL configuration (step S1404). The UL/DL configuration control unit 203 makes the change to the UL/DL configuration determined at step S1401 (step S1405).

If it is determined at step S1402 that the UL/DL configuration is not changed (step S1402: NO), the UL/DL configuration control unit 203 does not change the UL/DL configuration (step S1406) and terminates the process.

According to the fourth embodiment described above, an optimum pattern corresponding to the data traffic amount in operation may be selected for the UL/DL configuration determined in the first to third embodiments. As a result, the UL/DL data traffic amount between the UE and the base station may be handled flexibly and efficient communication can always be performed. At the same time, the communication may be performed by using the UL/DL configuration capable of reducing the interference with the neighboring cell as far as possible.

According to the embodiments described above, the number of the DL subframes having multiplexed CRSs transmitted from a cell acting as an interference source to a terminal communicating with a neighboring cell is controlled corresponding to the communication status of a terminal in the cell. As a result, interference with a terminal communicating with a neighboring cell may be reduced so as to prevent the degradation of the wireless quality between the base station and the terminal.

For a terminal communicating in a neighboring cell (the area overlapping with the neighboring cell), if no terminal is connected to the cell, a UL/DL configuration having a reduced number of DL subframes is used. As a result, the interference of CRSs with communication of a user (terminal) communicating with the neighboring cell may be suppressed, and the wireless performance (such as an SIR) may be improved to implement high-speed communication.

While the UL/DL configuration having the reduced number of DL subframes is used, the subframes having multiplexed CRSs themselves are sent out without being stopped. As a result, the compatibility with the communication mode of LTE may be maintained for a terminal on standby in the cell so as to suppress the degradation of wireless performance (synchronization performance).

However, since the communication mode of LTE always requires transmission of a CRS in a DL subframe, the technique described in Japanese Laid-Open Patent Publication No. 2012-249118 is not compatible with the communication mode of LTE and cannot be applied to the communication mode of LTE. In the communication mode of LTE, a terminal in a standby (idle) state present in the cell #B executes a synchronization process with the cell #B based on the CRS (CRS-B) multiplexed in the DL subframe of the cell B. Therefore, the communication mode of LTE causes a problem of degradation of synchronization performance of a terminal if the CRS (CRS-B) is not transmitted.

As described above, in the conventional techniques, a CRS is always transmitted in a DL subframe in the communication mode of LTE even if no connected user is present, and this CRS acts as an interference source for a user (terminal) communicating with a neighboring cell and causes degradation of wireless performance. On the other hand, if the technique of stopping the CRS transmission in DL subframes is used, this is not compatible with the communication mode of LTE and causes degradation of wireless performance at a user (terminal) located under the cell with the CRS transmission stopped. The degradation of wireless performance results in degradation of wireless quality in communications between a base-station and a terminal.

According to one embodiment, interference with a neighboring cell may be reduced and degradation of wireless quality may be suppressed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station apparatus comprising:
a memory; and
a processor coupled to the memory, the processor configured to:
determine whether a communicating terminal under a first cell is present, the processor changing a frame configuration of uplink and downlink to a frame configuration suppressing interference with a second cell neighboring the first cell when the communicating terminal is absent.

2. The base station apparatus according to claim 1, wherein
the processor changes the current frame configuration to a frame configuration having a reduced number of downlink subframes, when the communicating terminal under the first cell is absent.

3. The base station apparatus according to claim 1, wherein
the processor changes the frame configuration based on uplink and downlink data traffic amounts of the first cell.

4. The base station apparatus according to claim 3, wherein
the processor makes a change to the frame configuration having an increased number of uplink subframes when the uplink data traffic amount of the first cell is large, and makes a change to the frame configuration having an increased number of downlink subframes when the downlink data traffic amount of the first cell is large.

5. The base station apparatus according to claim 3, wherein
the processor preferentially selects a pattern reducing interference with the second cell as the frame configuration among a plurality of preset patterns of arrangement of numbers of uplink and downlink subframes.

6. The base station apparatus according to claim 1, wherein
the processor notifies a terminal in a standby state under the first cell of a change in the frame configuration before changing the frame configuration.

7. The base station apparatus according to claim 1, wherein
the processor, when a communicating terminal under the first cell is present after a change in the frame configuration, restores the frame configuration to that before the change.

8. The base station apparatus according to claim 1, wherein
the processor, when changing the frame configuration for the second cell, notifies the base station in the second cell of the change in the frame configuration.

9. The base station apparatus according to claim 8, wherein
the processor notifies the second cell of the change in the frame configuration before changing the frame configuration.

10. The base station apparatus according to claim 1, wherein
when a controller disposed on the base station apparatus of the second cell is notified of a change in the frame configuration by the base station apparatus of the first cell, the controller notifies a terminal under the second cell of the change in the frame configuration of the first cell.

11. The base station apparatus according to claim 1, wherein
the processor includes the frame configuration of the first cell into handover information supplied to the terminal at the time of handover of a communicating terminal under the second cell to the first cell.

12. A communication method implemented by a base station apparatus, the method comprising:
determining, by the base station apparatus, whether a communicating terminal under a cell of the base station apparatus is present; and
changing, by the base station apparatus when the communicating terminal is absent, a frame configuration of uplink and downlink to a frame configuration suppressing interference with a neighboring cell.

13. The communication method according to claim 12, wherein
the changing includes changing the current frame configuration to a frame configuration having a reduced number of downlink subframes, when the communicating terminal under the cell is absent.
